(19) United States
(12) Patent Application Publication
(10) Pub. No.: US 2018/0237220 A1
(43) Pub. Date: Aug. 23, 2018

(54) PIECE DISTRIBUTION PICKING/RESTOCKING SYSTEM

(71) Applicant: JB-Create, Inc., Ishikawa (JP)

(72) Inventor: Juro YAMAGISHI, Ishikawa (JP)

(21) Appl. No.: 15/594,495

(22) Filed: May 12, 2017

(30) Foreign Application Priority Data
Feb. 21, 2017 (JP) 2017-29560

(51) Int. Cl. B65G 1/04; B65G 15/00; B65G 1/137

(52) U.S. Cl. CPC B65G 1/0407; B65G 1/1373; B65G 15/00

(57) ABSTRACT

A piece distribution picking/restocking system includes a storage shelf; a box crane for storing and picking the merchandise storage boxes in the shelves and provided with a travel unit and a loading stand having a transfer unit; a working floor provided with two stories of a picking floor for fetching assigned merchandise out of the merchandise storage box picked by the box crane on the upper story and a restocking floor for restocking merchandise in a merchandise storage box on the lower story; and a lifter for conveying a merchandise storage box from which the assigned merchandise has been fetched on the picking floor to the restocking floor.

### BACKGROUND

### Technical Field

The present invention relates to a physical distribution system using an automatic crane and a storage shelf for efficiently performing a picking work and a restocking work of merchandise by a worker in piece distribution.

### Related Art

Physical distribution of long-tail products sold over the Internet is characterized by the storage of a huge number of merchandise items and the fetching, packing, and delivery of an ordered item from an individual customer.

A physical distribution system is divided into piece distribution of small articles (piece picking) and case distribution (case picking). The piece distribution is a method of storing merchandise on shelves, storing merchandise in an available shelf space with a corresponding shelf number assigned to each of regularly partitioned blocks of a shelf, i.e. a free location, picking orders in a certain unit, sorting the orders by customer, and packing and shipping the orders.

The picking work in the piece distribution is performed by a worker in such a way that with a portable computer terminal in his/her hand, he/she looks for a displayed location, walks, and fetches an intended item, and then scans a bar code for confirmation.

More than half of the picking work performed by a worker are the work of walking and the work of looking for the location of a shelf. Therefore, the number of items that the worker can pick in an hour is about 150. Though, if the number of pickings per item is large, the productivity is increased. However, it is BtoC distribution, and more than one order at a time is less frequent, so picking orders in a unit at once, i.e., a batch picking is performed, and yet the degree to which there are orders of the same item is low. If the productivity is low, naturally, the cost increases.

Furthermore, the storage on shelves requires a space for the shelves and aisles for workers to walk. The height of the shelves has to be the height workers can reach, and the space up to the ceiling cannot be used, which is wasteful. To increase the space efficiency, the picking area needs to be made up of three or four stories.

Arrived merchandise is inspected and restocked on the shelves. This is the work of looking for an available shelf space, scanning the merchandise and a shelf code, and putting the merchandise in the shelf. Just like the picking, the work of walking and the work of looking for a location take more than half of the entire work, and the productivity is low.

On the other hand, there has been disclosed the invention intended that even in a small- or medium-scale distribution center, a person responsible for receiving/shipping of merchandise can reduce waste motion, for example, according to a merchandise receiving/shipping work support system and merchandise receiving/shipping work support method as disclosed in JP 2010-83624 A, at the time of the receiving work, checking a due in list with information of not in stock can eliminate the need for the work of temporarily storing the received merchandise on a storage shelf, or, as long as the due in list includes the quantity of merchandise to be shipped on the same day, even if the merchandise shipping work for merchandise other than the quantity of merchandise to be shipped on the same day is not finished, the shelf put work can be performed, and, at the time of the shipping work, the merchandise shipping work for a picking list that includes merchandise to consignees with information of not in stock can wait, or a worker can be saved from going to a shelf of the merchandise with information of not in stock.

Besides the invention intended to make merchandise picking information or the like more efficient to reduce worker's burden caused by walking like JP 2010-33624 A, in recent years, there is a mechanism that a robot carries a case storing therein a single or multiple merchandise to a worker's working area, and, when the worker has finished picking assigned merchandise, the robot restores a merchandise storage box (case) to a box storage area. Accordingly, the hardest work that the worker walks can be reduced, however, there is a time lag between when the worker has finished picking merchandise of one merchandise storage box and when the next merchandise storage box is carried to in front of the worker, further, a space for the robot to get under a merchandise storage box is necessary, and the height of the shelves is within the worker's reach; therefore, it cannot be said that the productivity is high. Furthermore, in a distribution center using an automatic crane or a robot, in the current system, the lager the scale becomes, the longer the conveyor for carrying merchandise storage boxes or the like and the more complicated the configuration tends to be, and there may be a case in which the installation cost and installation area of the conveyor and the maintenance cost become problems.

### SUMMARY

The present invention is intended to provide a piece distribution picking/restocking system that achieves the picking of assigned merchandise from a merchandise storage box and the restocking of arrived merchandise in a merchandise storage box in a reduced space efficiently by using an automatic crane for storing and picking a merchandise storage box storing merchandise therein in a storage shelf in order to eliminate the work of walking and the waste work of looking for a picking location in the picking, thereby increasing the picking productivity and the restocking productivity without limit.

A first aspect of the present invention is a piece distribution picking/restocking system comprising:

a storage shelf provided with a plurality of lines of multi-tiered shelves for storing merchandise storage boxes;

a box crane for storing and picking the merchandise storage boxes in the shelves, the box crane provided with a travel unit and a loading stand having a transfer unit;

a working floor provided with two stories of a picking floor and a restocking floor, the picking floor provided for fetching assigned merchandise out of the merchandise storage box picked by the box crane, the restocking floor provided for restocking the merchandise in the merchandise storage box; and
a lifter for conveying the merchandise storage box from which the assigned merchandise has been fetched on the picking floor to the restocking floor.

A second aspect of the present invention is the piece distribution picking/restocking system according to claim 1, wherein
the box crane includes four box cranes, and the four box cranes are provided two by two in parallel and arranged so as to be opposed to each other centering on the working floor,
the storage shelf includes a plurality of storage shelves, and the storage shelves are arranged in parallel on both sides of the box cranes, and
the lifter includes a plurality of lifters, and the lifters are arranged in a manner corresponding to the box cranes.

A third aspect of the present invention is the piece distribution picking/restocking system according to claim 1, wherein
the picking floor includes:
   a box conveyor for conveying the merchandise storage box picked by the box crane to a predetermined location; and
   a tray conveyor for conveying a tray in which the merchandise that has been fetched from the merchandise storage box has been put.

A fourth aspect of the present invention is the piece distribution picking/restocking system according to claim wherein
the restocking floor includes:
   a receiving work area where the merchandise received by a receiving conveyor is unpacked, inspected, and lined up; and
   a restocking work area where the received merchandise is restocked in the merchandise storage box having been conveyed by the lifter.

A fifth aspect of the present invention is the piece distribution picking/restocking system according to claim 1, wherein
the box crane is provided with two lines of the loading stands in a traveling direction, and each of the loading stands is provided with two transfer units, and
while one of the transfer units of one of the loading stands performs work of picking the merchandise storage box, one of the transfer units of the other loading stand performs work of storing the merchandise storage box.

A sixth aspect of the present invention is the piece distribution picking/restocking system according to claim 2, wherein
the picking floor includes:
   a box conveyor for conveying the merchandise storage box picked by the box crane to a predetermined location; and
   a tray conveyor for conveying a tray in which the merchandise that has been fetched from the merchandise storage box has been put.

A seventh aspect of the present invention is the piece distribution picking/restocking system according to claim 2, wherein
the restocking floor includes:
   a receiving work area where the merchandise received by a receiving conveyor is unpacked, inspected, and lined up; and
   a restocking work area where the received merchandise is restocked in the merchandise storage box having been conveyed by the lifter.

A eighth aspect of the present invention is the piece distribution picking/restocking system according to claim 3, wherein
the restocking floor includes:
   a receiving work area where the merchandise received by a receiving conveyor is unpacked, inspected, and lined up; and
   a restocking work area where the received merchandise is restocked in the merchandise storage box having been conveyed by the lifter.

A ninth aspect of the present invention is the piece distribution picking/restocking system according to claim 6, wherein
the restocking floor includes:
   a receiving work area where the merchandise received by a receiving conveyor is unpacked, inspected, and lined up; and
   a restocking work area where the received merchandise is restocked in the merchandise storage box having been conveyed by the lifter.

A tenth aspect of the present invention is the piece distribution picking/restocking system according to any one of claim 2, further comprising:
the box crane is provided with two lines of the loading stands in a traveling direction, and each of the loading stands is provided with two transfer units, and
while one of the transfer units of one of the loading stands performs work of picking the merchandise storage box, one of the transfer units of the other loading stand performs work of storing the merchandise storage box.

An eleventh aspect of the present invention is the piece distribution picking/restocking system according to any one of claim 3, further comprising:
the box crane is provided with two lines of the loading stands in a traveling direction, and each of the loading stands is provided with two transfer units, and
while one of the transfer units of one of the loading stands performs work of picking the merchandise storage box, one of the transfer units of the other loading stand performs work of storing the merchandise storage box.

A twelfth aspect of the present invention is the piece distribution picking/restocking system according to any one of claim 6, further comprising:
the box crane is provided with two lines of the loading stands in a traveling direction, and each of the loading stands is provided with two transfer units, and
while one of the transfer units of one of the loading stands performs work of picking the merchandise storage box, one of the transfer units of the other loading stand performs work of storing the merchandise storage box.

A thirteenth aspect of the present invention is the piece distribution picking/restocking system according to any one of claim 7, further comprising:
the box crane is provided with two lines of the loading stands in a traveling direction, and each of the loading stands is provided with two transfer units, and
while one of the transfer units of one of the loading stands performs work of picking the merchandise storage box, one of the transfer units of the other loading stand performs work of storing the merchandise storage box.

A fourteenth aspect of the present invention is the piece distribution picking/restocking system according to any one of claim 8, further comprising:
the box crane is provided with two lines of the loading stands in a traveling direction, and each of the loading stands is provided with two transfer units, and
while one of the transfer units of one of the loading stands performs work of picking the merchandise storage box, one of the transfer units of the other loading stand performs work of storing the merchandise storage box.

A fifteenth aspect of the present invention is the piece distribution picking/restocking system according to any one of claim 9, further comprising:
the box crane is provided with two lines of the loading stands in a traveling direction, and each of the loading stands is provided with two transfer units, and
while one of the transfer units of one of the loading stands performs work of picking the merchandise storage box, one of the transfer units of the other loading stand performs work of storing the merchandise storage box.

According to the present invention, apiece distribution picking/restocking system can be set up in a reduced space, and therefore it is possible to make a distribution center highly efficient; furthermore, the working floor can be made up of two stories of the picking floor and the restocking floor, and a lifter conveys a merchandise storage box, and therefore the distance to convey a merchandise storage box is shortened dramatically, which can contribute to the reduction in the installation cost of a conveyor and the increase in the conveyance efficiency.

Moreover, worker's burden in the picking caused by the work of walking and the waste work of looking for a picking location can be reduced significantly, and further, if four box cranes can be installed, the box cranes can intensively convey merchandise storage boxes to the picking floor, and therefore, the worker's waiting time before the arrival of the merchandise storage boxes can be reduced significantly, and the worker's efficiency of picking merchandise can be increased.

### BRIEF DESCRIPTION OF DRAWINGS

FIGS. 1A and 1B are schematic plan views showing an embodiment of a piece distribution picking/restocking system according to the present invention; FIG. 1A is a schematic plan view showing an embodiment of a picking floor, and FIG. 1B is a schematic plan view showing an embodiment of a restocking floor;

FIG. 2 is a partial schematic side cross-sectional view showing the embodiment of the piece distribution picking/restocking system according to the present invention;

FIGS. 3A to 3C are diagrams showing an embodiment when the piece distribution picking/restocking system according to the present invention is applied to a distribution center; FIG. 3A is a plan view, FIG. 3B is a side view, and FIG. 3C is a front cross-sectional view; and

FIGS. 4A and 4B are schematic plan views when the piece distribution picking/restocking system according to the present invention includes two box cranes; FIG. 4A is a schematic plan view showing an embodiment of a picking floor, and FIG. 4B is a schematic plan view showing an embodiment of a restocking floor.

### DETAILED DESCRIPTION

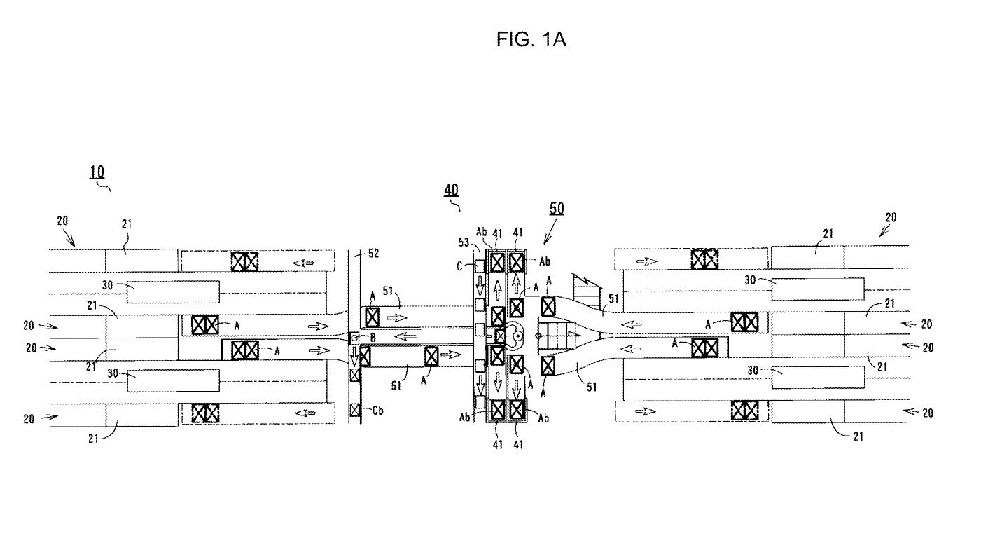

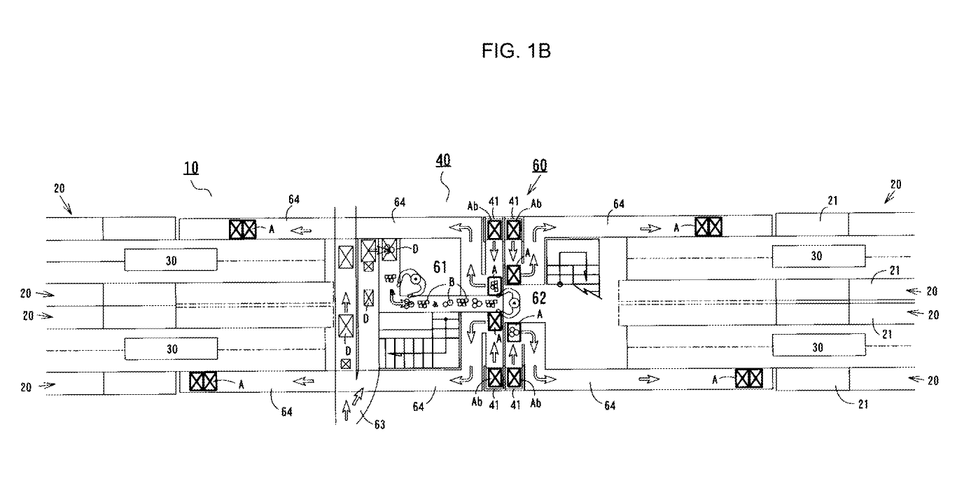

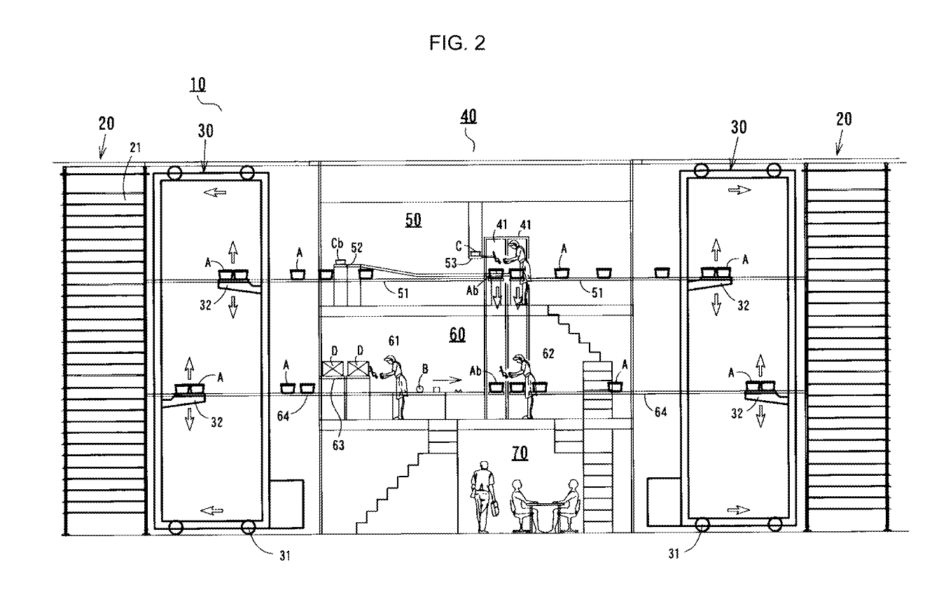

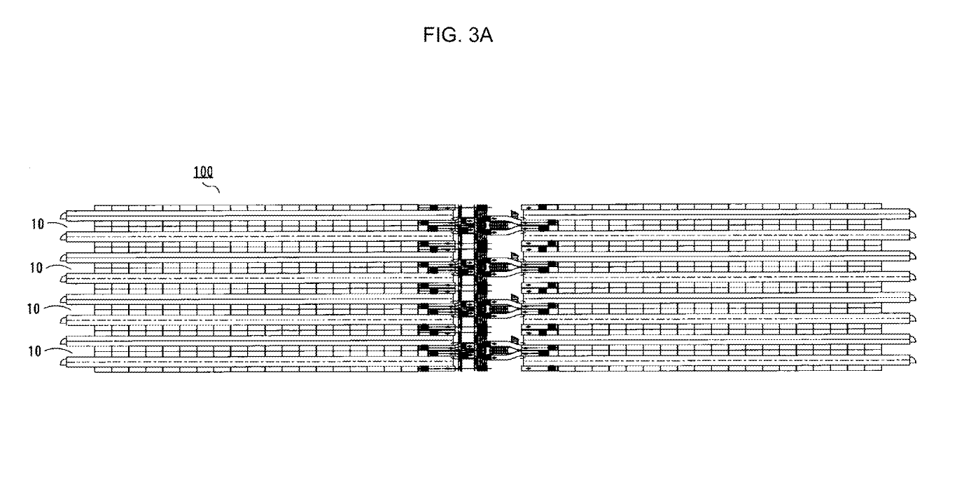

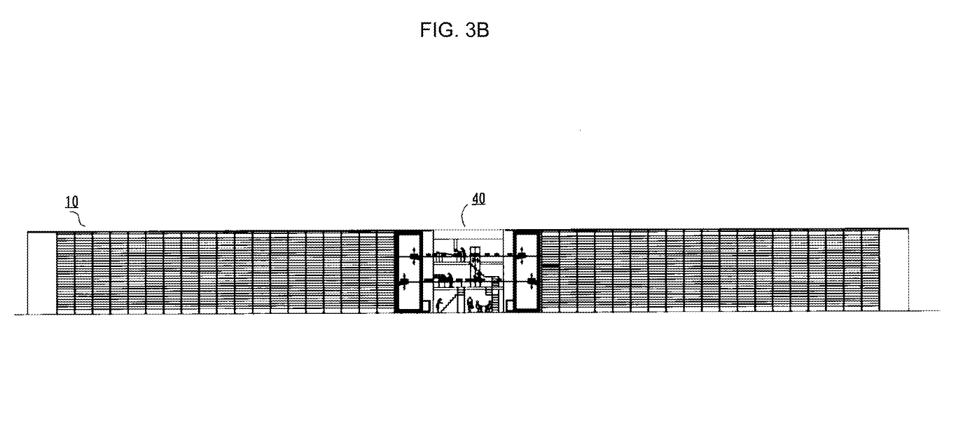

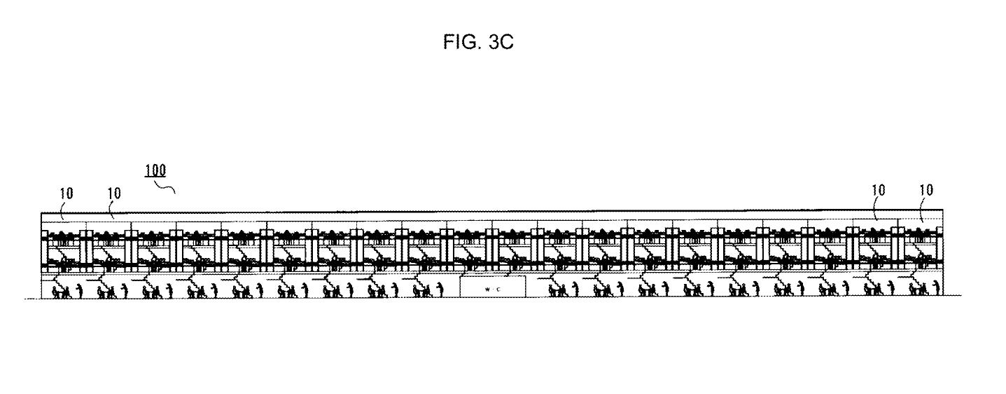

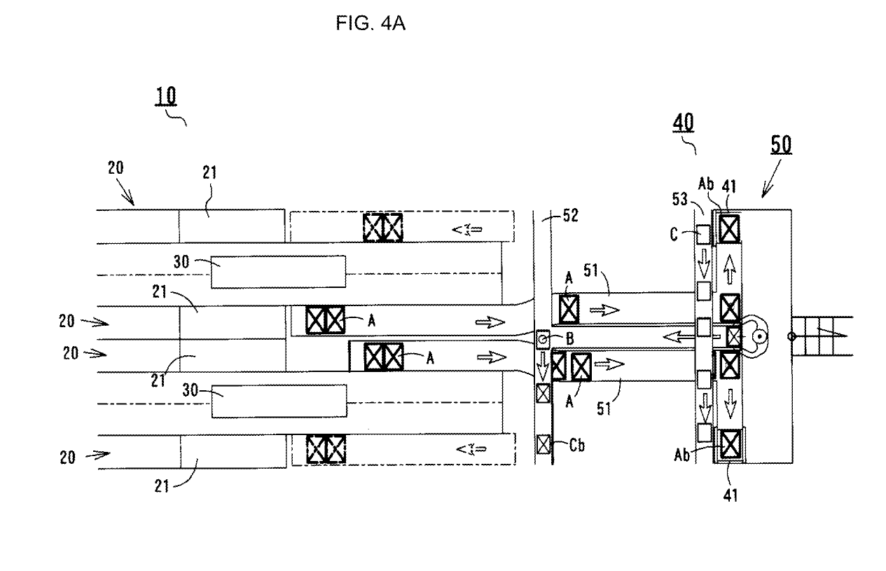

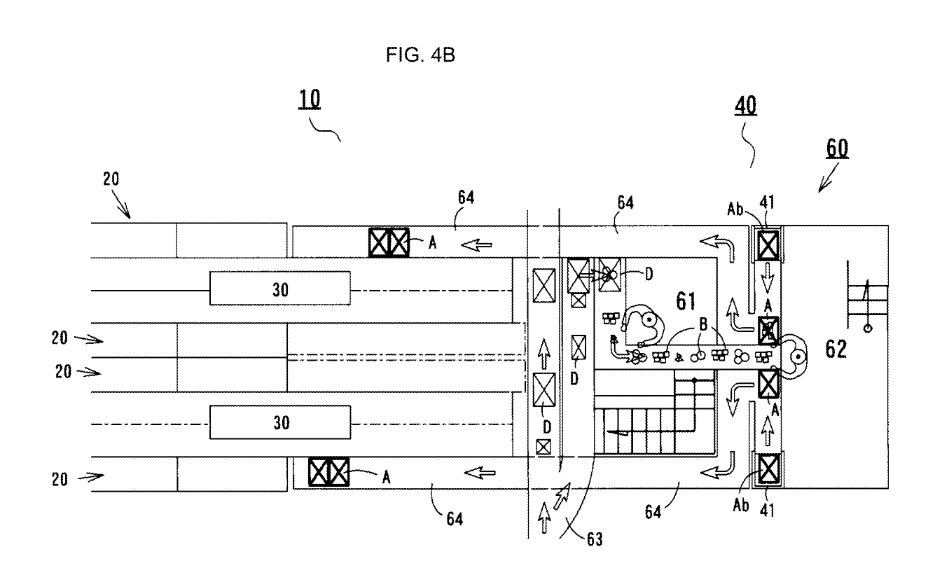

An example of embodiments of the present invention will be described in more detail below with reference to drawings. FIGS. 1A and 1B are schematic plan views showing an embodiment of a piece distribution picking/restocking system; FIG. 2 is a partial schematic cross-sectional view of the piece distribution picking/restocking system; FIGS. 3A to 3C are diagrams when the piece distribution picking/restocking system is applied to a distribution center. FIGS. 4A and 4B show an example of a layout when the piece distribution picking/restocking system includes two box cranes.

A piece distribution picking/restocking system 10 includes a storage shelf 20 provided with a plurality of lines of multi-tiered shelves 21 for storing merchandise storage boxes A; a box crane 30 for storing and picking the merchandise storage boxes A in the shelves 21 and provided with a travel unit 31 and a loading stand 32 having a transfer unit 33; a working floor 40 provided with two stories of a picking floor 50 for fetching assigned merchandise B out of the merchandise storage box A picked by the box crane 30 on the upper story and a restocking floor 60 for restocking merchandise B in a merchandise storage box A on the lower story; and a lifter 41 for conveying a merchandise storage box Ab from which the assigned merchandise B has been fetched on the picking floor 50 to the restocking floor 60. The four box cranes 30 are provided two by two in parallel and arranged so as to be opposed to each other centering on the working floor 40. The storage shelves 20 are arranged in parallel on both sides of each box crane 30. The lifters 41 are arranged in a manner corresponding to the box cranes 30. The box cranes 30 can be composed of two box cranes as shown in FIGS. 4A and 4B according to the installation space, or can be composed of three, although not shown in the drawing.

Furthermore, the piece distribution picking/restocking system 10 in the present embodiment is provided with a rest floor 70 on further below the working floor 40, and has a three-story structure in which workers can come and go to any floor by taking the stairs.

In the present embodiment, merchandise B, merchandise storage boxes A, and trays C are individually managed by a bar code assigned to each one; therefore, while managing what merchandise has been put in which merchandise storage box and stored in which storage shelf one by one, the piece distribution picking/restocking system 10 can send an instruction to a terminal on each working floor.

The box cranes 30 are, as shown in FIG. 2, each provided with the travel unit 31 and the loading stands 32 that are disposed in two lines and lift up and down independently; each of the loading stands 32 is provided with two transfer units 33. One of the loading stands 32 works exclusively for picking a merchandise storage box A, and the other loading stand 32 works exclusively for storage. Furthermore, while one of the transfer units 33 performs picking, one of the transfer units 33 of the loading stand 32 for storage performs storing. Accordingly, it is possible to perform the storage of a merchandise storage box A and the picking action in parallel.

The working floor 40 has a two-story structure, and is provided with the picking floor 50 for fetching assigned merchandise B out of a merchandise storage box A on the upper story and the restocking floor 60 for restocking merchandise B in a merchandise storage box A on the lower story. Incidentally, the picking floor 50 can be provided on the lower story, and the restocking floor 60 can be provided on the upper story.

The picking floor 50 is a floor for fetching assigned merchandise B out of a merchandise storage box A conveyed by a box crane 30, and is disposed so that one worker can work efficiently.

As shown in FIGS. 1A and 1B, the four box cranes 30 are provided two by two in parallel and arranged so as to be opposed to each other centering on the working floor 40, i.e., the picking floor 50, and are each provided with a box conveyor 51 for conveying a merchandise storage box A to a working space and then transferring the merchandise storage box A to the lifter 41, and the box conveyor 51 is arranged to surround worker's working space so that the worker can take merchandise B without walking. Accordingly, the worker can perform the work of taking merchandise B just by turning to the merchandise B, and therefore, not only the work efficiency can be improved, but also the physical burden can be reduced significantly. In the present embodiment, as shown in FIG. 1A, the courses of the four box conveyors 51 are configured so that particularly, the range of the body rotation angle can be kept to about 180 degrees. Incidentally, according to the scale of a distribution center and the type of merchandise handled, a merchandise storage box A can be picked by two box cranes 30 as shown in FIGS. 4A and 4B.

Furthermore, on the picking floor 50, it is configured to put a fetched merchandise B in a tray C and convey the tray, and there are provided a tray conveyor 52 for conveying a tray Cb with merchandise B put therein and an empty tray conveyor 53 for conveying an empty tray C in which merchandise B is to be put. In a distribution center 100, as shown in FIGS. 3A to 3C, a plurality of piece distribution picking/restocking systems 10 are provided in parallel, so by providing and connecting the tray conveyor 52 and the empty tray conveyor 53, merchandise B can be conveyed intensively, and the transfer of the merchandise B can be performed efficiently.

A pick completion merchandise storage box Ab from which merchandise B has been fetched is conveyed to the restocking floor 60 on the lower story by the lifter 41.

The restocking floor 60 is separated into a receiving work area 61 and a restocking work area 62; the receiving work area 61 is an area where merchandise B conveyed by a receiving conveyor 63 is unpacked from a received case D with the merchandise B packed therein, and the unpacking work is generally performed by one worker.

The restocking work area 62 is an area where the unpacked merchandise B is restocked in a pick completion merchandise storage box Ab having been conveyed from the picking floor 50 by the lifter 41 in accordance with an instruction from an information terminal, and the restocking work is generally performed by one worker.

The pick completion merchandise storage box Ab after the completion of the restocking, i.e., a merchandise storage box A is conveyed to a standby position of a box crane 30 and again stored in the storage shelf 20 by a shelf storage conveyor 64.

As shown in FIGS. 1A and 1B, the travel course of a merchandise storage box A is configured such that the merchandise storage box A is picked from a storage shelf 20 of a box crane 30, and assigned merchandise B is fetched on the picking floor 50, and then is conveyed to the restocking floor 60 by the lifter 41, and after that, merchandise B is restocked and stored on the storage shelf 20 by the same box crane 30; therefore, the merchandise storage box A circulates a short distance, so the length of the conveyor can be shortened extremely, and the conveyance efficiency can be improved significantly.

When the piece distribution picking/restocking system 10 is applied to the distribution center 100, as shown in FIGS. 3A to 3C, the piece distribution picking/restocking systems 10 are provided in parallel according to the size of the distribution center 100. Furthermore, it is configured such that, by connecting the tray conveyor 52, the empty tray conveyor 53, and the receiving conveyor 63, merchandise B scheduled to be shipped and put on the tray conveyor 52 can be collected in a lump, and empty trays C can be conveyed in a lump from abase point to a picking floor 50 by the empty tray conveyor 53, and merchandise B having been arrived by truck or the like can be conveyed in a lump from a base point to a restocking floor 60 by the receiving conveyor 63.

The piece distribution picking/restocking system 10 is configured such that a merchandise storage box A circulates a box crane 30, a picking floor 50, and a restocking floor 60; therefore, unlike a configuration of a conventional distribution center in which a merchandise storage box A is conveyed by a very long conveyor over the entire center, the length of the conveyor can be shortened extremely. Accordingly, the conveyance efficiency can be increased, and also the limit on operation, for example, due to maintenance of the conveyor can be reduced significantly, which brings an advantage that it can be operated without decreasing the merchandise picking efficiency.

The piece distribution picking/restocking system in the present invention is a system capable of efficiently performing the work of picking and restocking merchandise with a small number of workers in an automated warehouse such as a distribution center for picking various kinds and small quantity of merchandise.

1. A piece distribution picking/restocking system comprising:
a storage shelf provided with a plurality of lines of multi-tiered shelves for storing merchandise storage boxes;
a box crane for storing and picking the merchandise storage boxes in the shelves, the box crane provided with a travel unit and a loading stand having a transfer unit;
a working floor provided with two stories of a picking floor and a restocking floor, the picking floor provided for fetching assigned merchandise out of the merchandise storage box picked by the box crane, the restocking floor provided for restocking the merchandise in the merchandise storage box; and
a lifter for conveying the merchandise storage box from which the assigned merchandise has been fetched on the picking floor to the restocking floor.

2. The piece distribution picking/restocking system according to claim 1, wherein
the box crane includes four box cranes, and the four box cranes are provided two by two in parallel and arranged so as to be opposed to each other centering on the working floor,
the storage shelf includes a plurality of storage shelves, and the storage shelves are arranged in parallel on both sides of the box cranes, and
the lifter includes a plurality of lifters, and the lifters are arranged in a manner corresponding to the box cranes.

3. The piece distribution picking/restocking system according to claim 1, wherein
the picking floor includes:
a box conveyor for conveying the merchandise storage box picked by the box crane to a predetermined location; and
a tray conveyor for conveying a tray in which the merchandise that has been fetched from the merchandise storage box has been put.

4. The piece distribution picking/restocking system according to claim 1, wherein
the restocking floor includes:
a receiving work area where the merchandise received by a receiving conveyor is unpacked, inspected, and lined up; and
a restocking work area where the received merchandise is restocked in the merchandise storage box having been conveyed by the lifter.

5. The piece distribution picking/restocking system according to claim 1, wherein
the box crane is provided with two lines of the loading stands in a traveling direction, and each of the loading stands is provided with two transfer units, and
while one of the transfer units of one of the loading stands performs work of picking the merchandise storage box, one of the transfer units of the other loading stand performs work of storing the merchandise storage box.

6. The piece distribution picking/restocking system according to claim 2, wherein
the picking floor includes:
a box conveyor for conveying the merchandise storage box picked by the box crane to a predetermined location; and
a tray conveyor for conveying a tray in which the merchandise that has been fetched from the merchandise storage box has been put.

7. The piece distribution picking/restocking system according to claim 2, wherein
the restocking floor includes:
a receiving work area where the merchandise received by a receiving conveyor is unpacked, inspected, and lined up; and
a restocking work area where the received merchandise is restocked in the merchandise storage box having been conveyed by the lifter.

8. The piece distribution picking/restocking system according to claim 3, wherein
the restocking floor includes:
a receiving work area where the merchandise received by a receiving conveyor is unpacked, inspected, and lined up; and
a restocking work area where the received merchandise is restocked in the merchandise storage box having been conveyed by the lifter.

9. The piece distribution picking/restocking system according to claim 6, wherein
the restocking floor includes:
a receiving work area where the merchandise received by a receiving conveyor is unpacked, inspected, and lined up; and
a restocking work area where the received merchandise is restocked in the merchandise storage box having been conveyed by the lifter.

10. The piece distribution picking/restocking system according to any one of claim 2, further comprising:
the box crane is provided with two lines of the loading stands in a traveling direction, and each of the loading stands is provided with two transfer units, and
while one of the transfer units of one of the loading stands performs work of picking the merchandise storage box, one of the transfer units of the other loading stand performs work of storing the merchandise storage box.

11. The piece distribution picking/restocking system according to any one of claim 3, further comprising:
the box crane is provided with two lines of the loading stands in a traveling direction, and each of the loading stands is provided with two transfer units, and
while one of the transfer units of one of the loading stands performs work of picking the merchandise storage box, one of the transfer units of the other loading stand performs work of storing the merchandise storage box.

12. The piece distribution picking/restocking system according to any one of claim 6, further comprising:
the box crane is provided with two lines of the loading stands in a traveling direction, and each of the loading stands is provided with two transfer units, and
while one of the transfer units of one of the loading stands performs work of picking the merchandise storage box, one of the transfer units of the other loading stand performs work of storing the merchandise storage box.

13. The piece distribution picking/restocking system according to any one of claim 7, further comprising:
the box crane is provided with two lines of the loading stands in a traveling direction, and each of the loading stands is provided with two transfer units, and
while one of the transfer units of one of the loading stands performs work of picking the merchandise storage box, one of the transfer units of the other loading stand performs work of storing the merchandise storage box.

14. The piece distribution picking/restocking system according to any one of claim 8, further comprising:
the box crane is provided with two lines of the loading stands in a traveling direction, and each of the loading stands is provided with two transfer units, and
while one of the transfer units of one of the loading stands performs work of picking the merchandise storage box, one of the transfer units of the other loading stand performs work of storing the merchandise storage box.

15. The piece distribution picking/restocking system according to any one of claim 9, further comprising:
the box crane is provided with two lines of the loading stands in a traveling direction, and each of the loading stands is provided with two transfer units, and
while one of the transfer units of one of the loading stands performs work of picking the merchandise storage box, one of the transfer units of the other loading stand performs work of storing the merchandise storage box.
